(19) United States
(12) Patent Application Publication
(10) Pub. No.: US 2002/0113542 A1
(43) Pub. Date: Aug. 22, 2002

(54) Plasma picture screen with enhanced luminance

(76) Inventors: Hans-Helmut Bechtel, Roetgen (DE); Thomas Juestel, Aachen (DE); Harald Glaeser, Aachen (DE); Joachim Opitz, Aachen (DE)

Correspondence Address: U.S. Philips Corporation, 580 White Plains Road, Tarrytown, NY, 10591, US

(21) Appl. No.: 10/074,758

(22) Filed: Feb. 12, 2002

(30) Foreign Application Priority Data
Feb. 15, 2001 (DE) 10106963.4

(51) Int. Cl. H01J 1/62

(52) U.S. Cl. 313/491

(57) ABSTRACT

The invention describes a plasma picture screen, in particular an AC plasma picture screen, with enhanced luminance. The front plate (1) comprises a glass plate (3) to which a dielectric layer (4), a UV-reflecting layer (8), and a protective layer (5) are applied. The UV-reflecting layer (8) shows a high reflection in the wavelength range of the plasma emission (>172 nm) and a high transmission in the visible wavelength range. The UV-reflecting layer (8) reflects UV light (12) emitted in the direction of the front plate (1) back towards the phosphors (10).

The invention relates to a plasma picture screen provided with a front plate comprising a glass plate on which a dielectric layer and a protective layer are provided, with a back plate provided with a phosphor layer, with a ribbed structure which subdivides the space between the front plate and the back plate into plasma cells which are filled with a gas, and with one or more electrode arrays on the front plate and the back plate for generating corona discharges in the plasma cells.

Plasma picture screens render possible color pictures with high resolution and a large picture screen diagonal and are of compact design. A plasma picture screen comprises a hermetically sealed glass cell which is filled with a gas, with electrodes in a grid arrangement. A gas discharge which generates light in the ultraviolet range is generated through the application of a voltage. This light can be converted into visible light by phosphors and emitted through the front plate of the glass cell to the viewer.

Plasma picture screens are subdivided into two classes: DC plasma picture screens and AC plasma picture screens. The electrodes are in direct contact with the plasma in DC plasma picture screens. In AC plasma picture screens, the electrodes are separated from the plasma by a dielectric layer.

In a typical AC plasma picture screen, the dielectric layer is additionally overlaid with a layer of MgO. MgO has a high ion-induced secondary electron emission coefficient and thus reduces the ignition voltage of the gas. Moreover, MgO is resistant to sputtering by positively charged ions of the plasma.

The gas mostly used nowadays as the UV-generating ingredient is a rare gas mixture with xenon. The light generated during the plasma discharge lies in the vacuum ultraviolet (VUV) range. The emission wavelength of Xe is at 147 nm, and the emission wavelength of the excited Xe₂ excimer is at 172 nm.

The luminance of the plasma picture screen is a function largely of the efficiency of the VUV light in exciting the phosphors. JP 2000-011895 describes a plasma picture screen which has a UV-reflecting layer on the dielectric layer, for the purpose of enhancing the luminance. The UV-reflecting layer comprises a layer sequence of materials of different refractive indices. The manufacture of these layers is very complicated and expensive.

It is disadvantageous that no layer of MgO can be applied to the UV-reflecting layer because the layer of MgO is not transparent to VUV light.

It is an object of the invention to provide a plasma picture screen with improved luminance.

This object is achieved by means of a plasma picture screen provided with a front plate comprising a glass plate on which a dielectric layer, a UV-reflecting layer, and a protective layer are provided, with a back plate provided with a phosphor layer, with a ribbed structure subdividing the space between the front plate and the back plate into plasma cells which are filled with a gas, and with one or more electrode arrays on the front plate and the back plate for generating corona discharges in the plasma cells, wherein UV light with a wavelength of >172 nm is produced by said discharges.

It is preferred that UV light with a wavelength of between 200 and 350 nm is produced in the corona discharges.

The use of UV light with a wavelength of >172 nm, in particular in the region of 200 to 350 nm, for exciting the phosphors, renders it is possible to apply to the front plate not only the layer which reflects UV light but also a protective layer, which has an advantageous effect on the ignition voltage of the gas. Moreover, the TV-reflecting layer enhances the luminance of the plasma picture screen, because UV light emitted in the direction of the front plate is reflected towards the phosphors by the UV-reflecting layer.

It is particularly preferred for the gas to be selected from the group consisting of mercury vapor, Ne/N₂, and the halides of rare gases.

These gases emit light with a wavelength of >172 nm in a plasma discharge.

It is also preferred for the UV-reflecting layer to contain a material selected from the group consisting of metal oxides, metal fluorides, metal phosphates, metal polyphosphates, metal metaphosphates, metal borates, and diamond.

In the wavelength range from 173 to 700 nm, these materials exhibit no, or only a slight absorption and withstand high temperatures during the manufacture of a plasma picture screen.

It is particularly preferred for the UV-reflecting layer to contain particles with a particle diameter of less than 300 nm.

It is very particularly preferred for the UV-reflecting layer to contain particles with a particle diameter of between 20 nm and 150 nm.

Particles of this diameter have a substantially higher light scattering in the UV wavelength range than in the visible wavelength range.

It is advantageous for the layer reflecting UV light to have a thickness of 0.5 μm to 5 μm.

In addition to the scattering behavior of the individual (isolated) particles and its dependence on wavelength, the thickness of the layer of scattering particles also plays a part. The use of particles with a particle diameter of less than 300 nm, in particular with a particle diameter of between 20 and 150 nm, as well as a layer thickness of 0.5 μm to 5 μm, leads to a UV-reflecting layer which reflects strongly in the wavelength range of the plasma emission and transmits in the range of the visible light emission of the phosphors.

The invention will now be explained in more detail below with reference to two Figures and two embodiments, wherein:

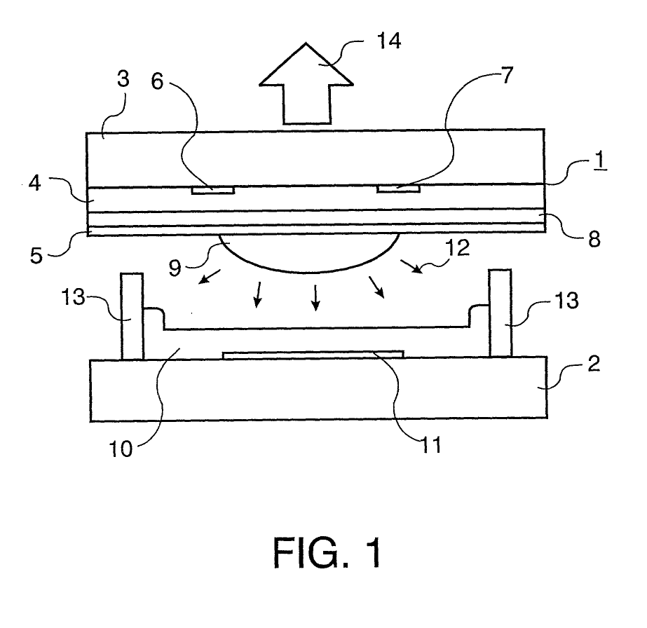

FIG. 1 shows the structure and the operating principle of an individual plasma cell in an AC plasma picture screen, and

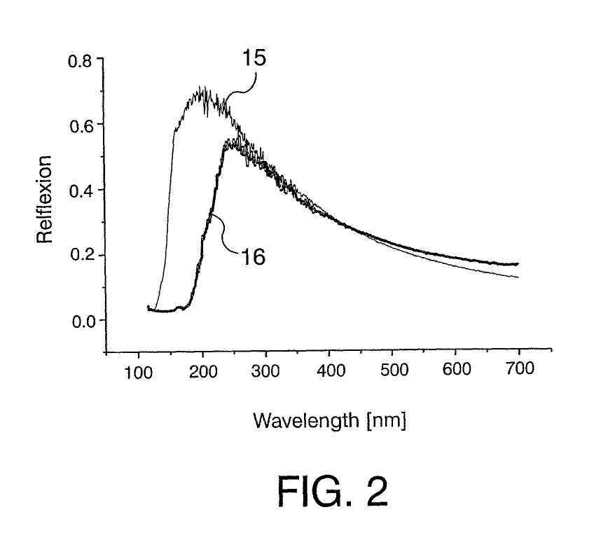

FIG. 2 shows the reflection behavior of a UV-reflecting layer according to the invention.

In FIG. 1, a plasma cell of an AC plasma picture screen with a coplanar arrangement of the electrodes has a front plate 1 and a back plate 2. The front plate 1 comprises a glass plate 3 on which a dielectric layer 4, a UV-reflecting layer 8 on the dielectric layer 4, and thereon a protective layer 5 are provided. The protective layer 5 is preferably made of MgO, and the dielectric layer 4 is, for example, made of PbO-containing glass. Parallel, strip-shaped discharge electrodes 6, 7 covered by the dielectric layer 4 are applied on the glass plate 3. The discharge electrodes 6, 7 are, for example, made of metal or ITO. The back plate 2 is of glass, and parallel, strip-shaped address electrodes 11, for example made of Ag, running perpendicular to the discharge electrodes 6, 7 are applied on the back plate 2. Said address electrodes are covered with a phosphor layer 10 which emits light in one of the three primary colors of red, green or blue. The phosphor layer 10 is for this purpose subdivided into a plurality of color segments. It is customary to apply the color segments of the phosphor layer 10 which emit in red, green, and blue in the form of perpendicular strip triplets. The individual plasma cells are separated by a ribbed structure 13 with separating ribs, preferably of a dielectric material.

A gas which emits light in the event of a plasma discharge, the maximum of the emitted wavelength being >172 nm, is present in the plasma cell, and also between the discharge electrodes 6, 7, of which one acts as a cathode and the other as an anode and vice versa in alternation. Light in a wavelength range of between 200 and 350 nm is preferably generated in the plasma discharge. After ignition of the surface discharge, as a result of which charges can flow along a discharge path situated between the discharge electrodes 6, 7 in the plasma region 9, a plasma is formed in the plasma region 9 by means of which radiation 12 in the UV region is generated, depending on the composition of the gas. This radiation 12 excites the phosphor layer 10 into luminescence so that it will emit visible light 14 in one of the three primary colors which light issues through the front plate 1 and thus forms a luminous pixel on the picture screen.

The discharge electrodes 6, 7 are first provided by vapor deposition methods on a glass plate 3 whose size corresponds to the desired picture screen size, so as to manufacture a front plate 1 with a UV-reflecting layer 8. Then the dielectric layer 4 is applied.

Suspensions of the particles with the desired particle diameters are first prepared so as to produce the UV-reflecting layer 8. Oxides, fluorides, phosphates, metaphosphates or polyphosphates, for example, of various main group metals or transition group metals may be used for the particles. For example, the oxides of the 1st main group such as Li₂O or oxides of the 2nd main group such as MgO, CaO, SrO and BaO, or oxides of the 3rd main group such as, for example, B₂O₃ and Al₂O₃, or oxides of the 3rd transition group such as Sc₂O₃, Y₂O₃ and La₂O₃,or oxides of the 4th main group such as, for example, SiO₂, GeO₂ and SnO₂, or oxides of the 4th transition group such as TiO₂, ZrO₂ and HfO₂, or mixed oxides such as MgAl₂O₄, CaAl₂O₄, or BaAl₂O₄, for example, may be used as the oxides. Fluorides of the 1st main group such as LiF, NaF, KF, RbF and CsF, or fluorides of the 1st transition group such as AgF, or fluorides of the 2nd main group such as MgF₂, CaF₂, SrF₂ and BaF₂, or fluorides of the 3rd main group such as AlF₃, or fluorides of the 4th main group such as PbF₂, or fluorides of the 1st transition group such as CuF₂, or fluorides of the 2nd transition group such as ZnF₂, or fluorides of the lanthanides such as LaF₃, CeF₄, PrF₃, SmF₃, EuF₃, GdF₃ YbF₃ and LuF₃, or mixed fluorides such as LiMgF₃, Na₃AlF₆ and KMgF₃, for example, may be used as the fluorides. Phosphates of the 1st main group such as Li₃PO₄, Na₃PO₄, K₃PO₄, Rb₃PO₄ and Cs₃PO₄, or phosphates of the 2nd main group such as Mg₃(PO₄)₂, Ca₃(PO₄)₂, Sr₃(PO₄)₂ or Ba₃(PO₄)₂, or phosphates of the 3rd main group such as AlPO₄, or phosphates of the 3rd transition group such as ScPO₄, YPO₄ and LaPO₄, or phosphates of the lanthanides such as LaPO₄, PrPO₄, SmPO₄, EuPO₄, GdPO₄, YbPO₄ and LuPO₄, or phosphates of the 4th transition group such as Ti₃(PO₄)₄, Zr₃(PO₄)₄ and Hf₃(PO₄)₄, for example, may be used as the phosphates. Metaphosphates of the 1st main group such as Li₃(PO₃)₃, Na₃(PO₃)₃, K₃(PO₃)₃, Rb₃(PO₃)₃ and Cs₃(PO₃)₃, or metaphosphates of the 2nd main group such as Mg(PO₃)₂, Ca(PO₃)₂, Sr(PO₃)₂ and Ba(PO₃)₂, or metaphosphates of the 3rd main group such as Al(PO₃)₃, or metaphosphates of the 3rd transition group such as Sc(PO₃)₃, Y(PO₃)₃ and La(PO₃)₃, or metaphosphates of the 4th transition group such as Ti₃(PO₃)₄, Zr₃(PO₃)₄ and Hf₃(PO₃)₄ or Zn(PO₃)₂, for example, may be used as metaphosphates with a chain length n of between 3 and 9. The polyphosphates used may be, for example, polyphosphates (MₓPO₃)ₙ of the metals Li, Na, K, Rb, Cs, Mg, Ca, Sr, Ba, Al, Sc, Y, La, Ti, Zr, Hf, Zn Pr, Sm, Eu, Gd, Yb, or Lu with a chain length n of between 10¹ and 10⁶ and with a value for x which lies between 0.25 and 1, depending on the oxidation stage of the metal used. Metal cations may also be partly replaced by protons in all these polyphosphates. However, it is also possible to use hydrogen phosphates such as, for example, KH₂PO₄, NaH₂PO₄ and NH₄H₂PO₄, or diamond in the UV-reflecting layer 8.

The particle diameter of the materials used should be smaller than 300 nm and preferably lies in a range of between 20 and 150 nm. It is particularly advantageous when there is a wide distribution over this range of particle diameters, because this influences the ratio of reflection of the UV light to the reflection of visible light in the desired direction.

Alternatively, the suspensions may contain precursors of the particles according to the invention, which precursors are then converted into the desired particles by means of a thermal treatment. Thus, for example, a suspension with Mg(OH)₂ may be thermally converted into a layer of MgO after being provided the dielectric layer 4.

The suspensions is preferably prepared in an aqueous solution. In many cases, it may be necessary to work with organic solvent systems, for example if the powder used reacts chemically with water or dissolves therein. The suspensions are prepared in various ways, depending on the material and the particle diameter. One possibility is for the particles to be synthesized from suitable precursors. The alternative possibility is for the particles to be inserted directly.

If particles are produced from precursors in the preparation of the suspensions, metal salts are first dissolved in water. The metal salts have the composition MXₙ●yH₂O, M being, for example, one or more metals selected from the group consisting of Li, Na, K, Rb, Cs, Mg, Ca, Sr, Ba, Al, Sc, La, Y, Sn, Ti, Zr, Hf, Ag, Pb, Cu, Pr, Sm, Eu, Gd, Yb, Lu, and Zn. X is, for example, one or more of the anions NO₃⁻, RO⁻, R—COO⁻, ⁻O₂C—CO₂⁻, while y is a number greater than or equal to zero, and n is an integer number between 1 and 4, depending on the oxidation stage of the metal cation Mⁿ⁺. Propoxides and butoxides, for example, may be used as the alkoxide RO⁻. The carboxylates used may be, for example, acetates, propionates or butyrates.

The particles according to the invention with a particle diameter of less than 300 nm are then obtained by thermal treatment such as, for example, heating under reflux, by an acid treatment, for example addition of acetic acid, by an alkali treatment such as the addition of sodium hydroxide solution or direct addition of ammonia, and/or by the addition of the desired complementary ions. The complementary ions are added as salts to the aqueous metal salt solution and may be, for example, ammonium salts such as NH₄F, or phosphates such as sodium metaphosphate, or long-chain polyphosphate salts.

The suspensions obtained are admixed with an associative thickener and/or a dispersing agent.

Alternatively, particles such as, for example, Li₂O, MgO, CaO, SrO, BaO, B₂O₃, Al₂O₃, Sc₂O₃, Y₂O₃, La₂O₃, SiO₂, GeO₂, SnO₂, TiO₂, ZrO₂, HfO₂ or MgAl₂O₄ with a particle diameter of less than 300 nm may be suspended directly in an aqueous solution and subsequently admixed with an associative thickener and/or a dispersing agent.

The particles may be dispersed through milling with a ball mill with or without a stirrer, stirring with a dissolver, shear dispersion using an Ultraturrax machine, an ultrasound bath, or an ultrasound sonotrode.

The suspensions may be laced, furthermore, with additives which modify the flow properties of the suspensions and lend them thixotropic properties. Small quantities of soluble organic polymers such as polyvinyl alcohol, polyacrylate derivatives, associatively acting thickeners, or fully dispersed colloids may be used as such additives.

The suspensions obtained in these different ways may be applied to the dielectric layer 4 of the front plate 1 by a variety of methods such as, for example, spin coating, meniscus coating, blade coating, screen printing or flexographic printing.

In order to dry the applied layer, the latter is treated with ambient air, heat, infrared radiation or combinations thereof. Drying is carried out sufficiently slowly in order to prevent the formation of cracks in the layer owing to shrinkage. The layers are given a thermal aftertreatment in order to remove admixed materials such as the electrolytes, the dispersing agents, or the polymers. The additives can be removed without residue through heating of the layers to 450° C. It may be necessary in some cases to apply temperatures of 600° C. in order to achieve a complete pyrolysis of the polymers. If the applied suspension contains a precursor of a particle according to the invention, the relevant conversion will take place simultaneously with the thermal treatment.

An inert gas halide such as, for example, ArF, KrCl, KrF, XeBr, XeCl, XeF, an Ne/N₂ mixture, or mercury vapor may be used as the gas for the plasma discharge.

Phosphors which can be excited by wavelengths of >172 nm, in particular in a wavelength range between 200 and 350 nm, are used in the phosphor layer 10.

BaMgAl₁₀O₁₇:Eu, (Ba₁₋ₓSrₓ)₅(PO₄)₃(F,Cl):Eu with 0≦x≦1 or (Ba_{1-x-y}SrₓCa_{y})₅(PO₄)₃(F,Cl):Eu with 0≦x≦1, for example, may be used as a blue-emitting phosphor.

Zn₂SiO₄:Mn, BaAl₁₂O₁₉:Mn, Y₂SiO₅:Tb, CeMgAl₁₁O₁₉:Tb, (Y₁₋ₓGdₓ)BO₃:Tb with 0≦x≦1, InBO₃:Tb, GdMgB₅O₁₀:Ce,Tb, or LaPO₄:Ce,Tb, for example, may be used as a green-emitting phosphor.

Y₂O₃:Eu, Y₂O₂S:Eu, YVO₄:Eu, Y(V₁₋ₓPₓ)O₄:Eu with 0≦x≦1, (Y₁₋ₓGdₓ)₂O₃:Eu with 0≦x≦1, or (Y₁₋ₓGdₓ)BO₃:Eu with 0≦x≦1, for example, may be used as a red-emitting phosphor.

To manufacture a segmented phosphor layer 10, known methods are used for producing a phosphor preparation with a green-, red-, or blue-emitting phosphor, and these are applied by means of dry coating methods, for example electrostatic deposition or electrostatically supported dusting, and also by means of wet coating methods, for example screen printing, dispenser processes in which a phosphor preparation is introduced by means of a nozzle moving along the channels, or sedimentation from the liquid phase, to a back plate 2 with a ribbed structure 12 with separating ribs and address electrodes 10. This method is subsequently carried out for the two other colors.

Together with further components such as, for example, a front plate 1 and a gas, the back plate 2 is used to manufacture a plasma picture screen.

The UV-reflecting layer 8 is preferably used for AC plasma picture screens in which the plasma cells are driven by an AC voltage and in which the discharge electrodes 6, 7 are covered by a dielectric layer 4. It also possible in principle to use a UV-reflecting layer for DC plasma picture screens in which the discharge electrodes 6, 7 are not covered by a dielectric layer 4.

Embodiments of the invention will now be explained in detail below, representing examples of how the invention may be carried into practice.

Embodiment 1

To produce a silk-screen printing paste, 100 g p-menth-1-en-8-ole containing 5% by weight of ethyl cellulose, 2.7 g of a thixotropic agent, and 12 g SiO₂ with a particle diameter of between 20 and 110 nm were mixed and subsequently dispersed by passing twice through a three-roll roller mill.

Silk-screen printing was used to apply a layer of SiO₂ particles as a UV-reflecting layer 8 to the dielectric layer 4 of a front plate 1, which comprises a glass plate 3, a dielectric layer 4, and two discharge electrodes 6, 7. The dielectric layer 4 contained PbO, and the two discharge electrodes 6, 7 were made of ITO. The front plate 1 was first dried and then subjected to a thermal aftertreatment at 450° C. for 2 hours. The layer thickness of the UV-reflecting layer 8 of SiO₂ was 4.0 μm. Subsequently, the UV-reflecting layer 8 was coated with a layer of MgO with a layer thickness of 730 nm. The finished front plate 1 was used together with a back plate 2 and a gas to construct a plasma picture screen which had an enhanced luminance. The gas contained 90% of Ne by volume and 10% of N₂ by volume.

In FIG. 2, curve 15 shows the reflection of the 4.0 μm UV-reflecting layer 8 containing SiO₂ as a function of wavelength. Curve 16 shows the reflection after the 730 nm thick protective layer 5 of MgO had been vapor-deposited on the UV-reflecting layer 8.

Embodiment 2

150 g Al₂O₃ produced by flame pyrolysis with a particle diameter of up to 200 nm was stirred slowly into a 0.005 molar solution of ammonium acetate in 500 ml distilled water by means of a stirrer. After the addition had been completed, the suspension 15 obtained was treated for 15 min with an ultrasound sonotrode. The suspension was admixed with 25.0 ml of a 4.7% aqueous polyvinyl alcohol solution while being stirred. The suspension was subsequently cleaned by filtration.

Spin coating was used to apply a layer of Al₂O₃ particles as the UV-reflecting layer 8 to the dielectric layer 4 of a front plate 1 comprising a glass plate 3, a dielectric layer 4, and two discharge electrodes 6, 7. The dielectric layer 4 contained PbO, and the two discharge electrodes 6, 7 were made of ITO. The front plate 1 was first dried and then subjected to a thermal aftertreatment at 450° C. for 2 h. The layer thickness of the UV-reflecting layer 8 of Al₂O₃ was 2.0 μm. The UV-reflecting layer 8 was then coated with a layer of MgO which had a layer thickness of 600 nm. The finished front plate 1 was used together with a back plate 2 and a gas to construct a plasma picture screen with an enhanced luminance. The gas contained KrF.

1. A plasma picture screen provided with a front plate (1) comprising a glass plate (3) to which a dielectric layer (4), a UV-reflecting layer (8), and a protective layer (5) are applied, with a back plate (2) provided with a phosphor layer (10), with a ribbed structure (13) subdividing the space between the front plate (1) and the back plate (2) into plasma cells which are filled with a gas, and with one or more electrode arrays (6, 7, 11) on the front plate (1) and the back plate (2) for generating corona discharges in the plasma cells, wherein UV light with a wavelength of >172 nm is produced by said discharges.

2. A plasma picture screen as claimed in claim 1, characterized in that UV light with a wavelength of between 200 and 350 nm is produced in the corona discharges.

3. A plasma picture screen as claimed in claim 1, characterized in that the gas is selected from the group comprising mercury vapor, Ne/N₂, and the halides of rare gases.

4. A plasma picture screen as claimed in claim 1, characterized in that the UV-reflecting layer (8) comprises a material selected from the group comprising metal oxides, metal fluorides, metal phosphates, metal polyphosphates, metal metaphosphates, metal borates, and diamond.

5. A plasma picture screen as claimed in claim 1, characterized in that the UV-reflecting layer (8) contains particles with a particle diameter of less than 300 nm.

6. A plasma picture screen as claimed in claim 4, characterized in that the UV-reflecting layer (8) contains particles with a particle diameter of between 20 nm and 150 nm.

7. A plasma picture screen as claimed in claim 1, characterized in that the UV-reflecting layer (8) has a thickness of 0.5 μm to 5 μm.
